(19) United States
(12) Patent Application Publication
(10) Pub. No.: US 2004/0255136 A1
(43) Pub. Date: Dec. 16, 2004

(54) Method and device for protecting information against unauthorised use

(76) Inventor: Alexey Borisovich Fadyushin, Krasnogorsk (RU)

Correspondence Address: FAY KAPLUN & MARCIN, LLP, 15O BROADWAY, SUITE 702, NEW YORK, NY, 10038, US

(21) Appl. No.: 10/495,507

(22) PCT Filed: Nov. 12, 2001
(86) PCT No.: PCT/RU01/00476

(51) Int. Cl. G06F 12/14

(52) U.S. Cl. 713/193

(57) ABSTRACT

Described are method and device for protecting information against unauthorized use. Information obtained by the user is encrypted using an asymmetrical cryptography method with a user's key which is received by a distributor of information. The information is decoded before the use thereof with the aid of a private key of the user. Decryption may be carried out directly in a CPU of the user's computer user so that the decrypted information does not exist outside the processor.

### FIELD OF INVENTION

The present invention relates to protection of information (e.g., a software program, data, etc.) against unauthorized use. It specifically relates to a system and method of protection utilizing data encryption using asymmetrical cryptography methods with possibility to identification a person, releasing the copy of protected data without authorization hereto.

### BACKGROUND INFORMATION

At the present time the problem of information security against unauthorized copying becomes more and more critical. A particular attention is given to program security against a pirate distribution which cause a significant damage to software manufacturers.

Conventional methods of program protection could be divided into two major categories: hardware and software security.

When using hardware security methods (e.g., described in U.S. Pat. Nos. 5,826,011 & 6,308,170), the purchased software is accompanied with a certain technical device connected to a computer on which the software is used. The program sends a request to the device and based on a reply of the device, the program determines whether the its use is authorised by the manufacturer.

Such method has several disadvantageous features: utilization of additional equipment significantly increase the cost of software. Moreover, such method makes it difficult for a user to simultaneously utilize a single copy of purchased software on several computers, even if the license agreement allows for such utilization, since the user has to move protection equipment between computers. This method is frequently used so that it allows the creation of an emulator of protection equipment with a further distribution of pirate copies of the program together with such emulator. The other method to bypass such protection is to detect in a program's source code locations of reply from such device against calculated a template and elimination these check from code (e.g., by replacing conditional transfer to unconditional).

Software security methods, as a rule, are based on serial numbers submitted to consumer when the program is purchased (e.g., U.S. Pat. No. 6,134,659).

These serial numbers, entered by a user during installation or utilization of a program, are normally further compared with a template which is either a constant specified in the program, or a function from the user's data and/or an equipment of the user's computer, forwarded to a program's manufacturer for generation of a serial number. Sometimes a serial number is utilized as a key for decryption of encrypted source code or its parts.

Disadvantageous feature of this method is the possibility for illegal distribution of unlicensed copies of the program together with a serial number, if it does not depend on individual configurations of the user's computer. In case such correlation exists, this creates a significant load on a user support service which has to provide registered users with a new serial number every time they change (e.g., in case of upgrade or failure) computers elements, on which such number rely on. This is also inconvenient for the users who, after replacement of computer parts, cannot use formerly purchased software, until they communicate the new computer configuration to its manufacturer and receive a new number in reply. In this case, there is a possibility which is left to eliminate from the source code the check for correctness of a serial number (e.g., if it is not used as a key for code decryption).

### SUMMARY OF INVENTION

The present invention offers a method and program security system against unauthorized copying with the use of a method which significantly reduce or eliminate drawbacks of conventional methods.

More specifically, the present invention describes a method and security system with the use of asymmetrical cryptography algorithms. This allows for fixing a program copy to a specific Consumer, as well as for providing for lower probability for distribution among numerous Consumers of a single program copy legally purchased by one of them. In case when such distribution occurred, there is a possibility to locate the Consumer distributing illegal copies, in order to apply legislative actions against such Consumer.

One of the methods of the present invention provides for encryption of an executable code of a program copy when it is sold using an asymmetrical cryptography method with a public key obtained by the Consumer. The encrypted program copy, using the above-described method, prepared for sales to a specific Consumer, cannot be decrypted, and therefore, cannot be executed by anybody besides the Consumer who has a private key which makes a pair with a public key, used when the program copy was sold.

The present invention gives an important technical advantage, providing for program execution only by the Consumer, who bought it from the Vendor.

The present invention provides for another important technical advantage, allowing to determine, which Consumer submitted it's program copy for illegal copying, without possibility to deny this fact by the Consumer.

The present invention provides for another important technical advantage, giving the Consumer a possibility to change computer configuration on which the protected program is running, without addressing to program's Vendor for a new key after that.

The present invention provides for another important technical advantage, giving the Consumer a possibility to execution of protected program on any accessible computer, and not only on the Consumer's computer, the features of which were known to program's Vendor.

The present invention provides for another important technical advantage, giving the possibility both to Consumer and the Vendor to revoke program copies, matching with respective private keys of uncontrollable Consumers, making it impossible to execute these copies by persons who got access to such keys.

The present invention also provides for another important technical advantage, allowing the Consumer to remember only one serial number for all utilized programs, this number is the Consumer's private key or password for access to such key.

### BRIEF DESCRIPTION OF DRAWINGS

For better understanding of the present invention and its advantages, hereby a reference is made to the following description which is considered jointly with attached drawings, where the respective numbers represent the respective elements, and where:

FIG. 1 shows a process for generating and executing a program protected according to an exemplary embodiment of the present invention.

FIG. 2 shows a process for executing the protected program when a revocation check of a private key is made.

FIG. 3 shows a process for executing the protected program, when decryption of a source code is performed in the course of its execution.

FIG. 4 shows a structural diagram of a computer, in which CPU contains a special module for checking Consumer rights for program execution.

FIG. 5 shows a process for generating and executing the protected program when both methods of symmetrical and asymmetrical cryptography are simultaneously utilized.

### DETAILED DESCRIPTION

The preferable embodiments of the present invention are shown in figures, identical numbers are used as reference for identical and correlating parts of different drawings.

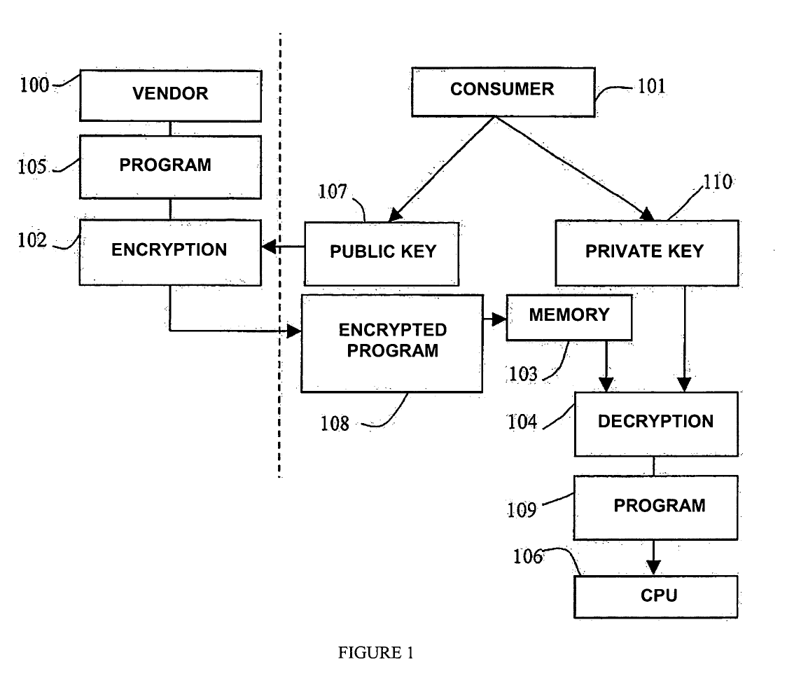

FIG. 1 shows one of the implementations of a program security system against unauthorized use. Consumer 101, willing to purchase a copy of a program 105, sends to Vendor 100 its public key 107 (e.g., as a part of a digital certificate). In case of purchasing the program 105 via the Internet, when the SSL protocol is used, it is possible to use the feature of this protocol—request for a public key 107. After obtaining such public key 107, the Vendor 100 encrypts the program 105 with this key 107 utilising an asymmetrical algorithm 102 (e.g., see U.S. Pat. No. 4,405,829). The Vendor 100 sends to the Consumer 101 an encrypted program 108 which was obtained as a result of this operation. The Consumer can save the encrypted program 108 in a memory 103 of its computer. The memory 103 may be any information storage device, including RAM, hard drive and tapes.

When executing the encrypted program 108 after removing from the memory 103, it is decrypted using an asymmetrical algorithm 104 (which corresponds to the algorithm 102) with a private key 110 of the Consumer corresponding the public key 107. A decrypted program 109, which is identical to the program 105, is sent for execution to a CPU 106 of the Consumer's computer.

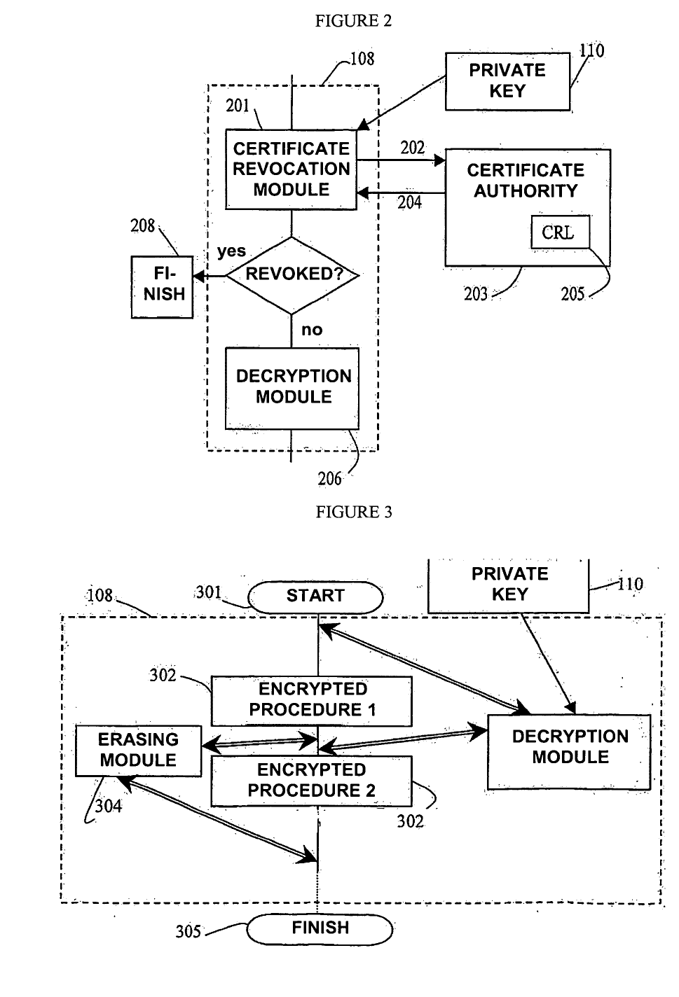

FIG. 2 shows the executable encrypted program 108 which includes a certificate revocation module 201 for revocation check of the private key 110. This module 201, after receiving the private key 110 as part of the Consumer's certificate, determines through information accompanying the key 110, a location of certificate revocation lists (CRL) 205. After that the program 108 sends a request 202 to a storage 203 of the CRL 205 (e.g., the storage 203 may be a certificate authority which authenticates the public key 107).

A reply 204 received from the certificate authority may include information on revocation of the private key 110. This reply may also include a digital signature so that the requesting program 108 can verify its authentication. Depending on the reply, the encrypted program 108 either cancels its execution or delegates an administration of a main part of the code to a decryption module 206.

FIG. 3 shows the encrypted program 108 which decrypt procedures'code immediately prior to their execution in order to complicate the process of bypassing protection by copying memory section, including a decrypted source code. Such program 108 contains one or more encrypted procedure 302. When in the execution process of the program 108, there may be a necessary to forward the administration to such a section. In this case, the decryption module 206, which decrypts only this section of the program 108, is called out. At the end of execution of the encrypted procedure 302, a memory erasing module 304 may be called out which deletes the decrypted section code of the encrypted program 108 in the memory 103.

This process is repeated during execution of the next encrypted section.

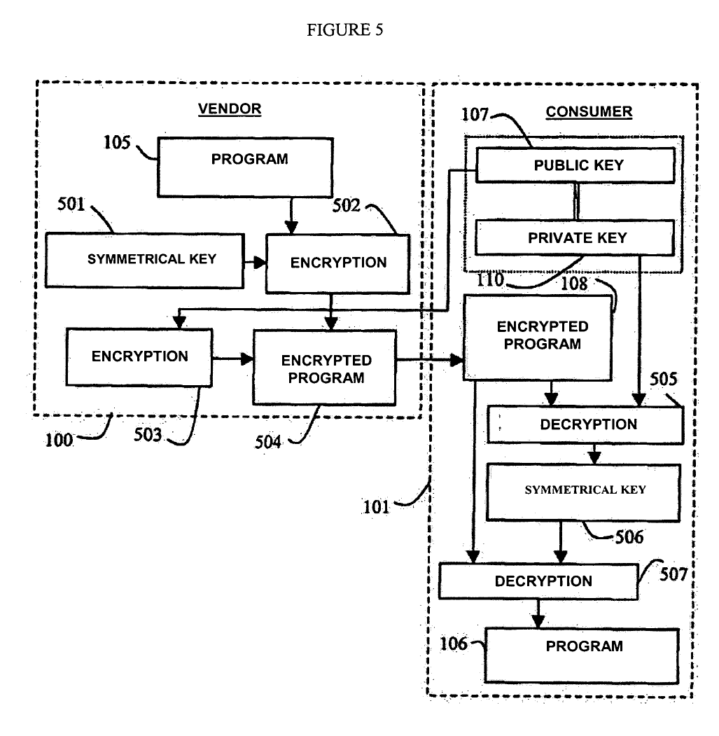

For further complication of bypassing protection in case, when both methods of symmetrical and asymmetrical cryptography are used simultaneously, as shown on FIG. 5, different symmetrical keys can be used for encryption of various parts of program.

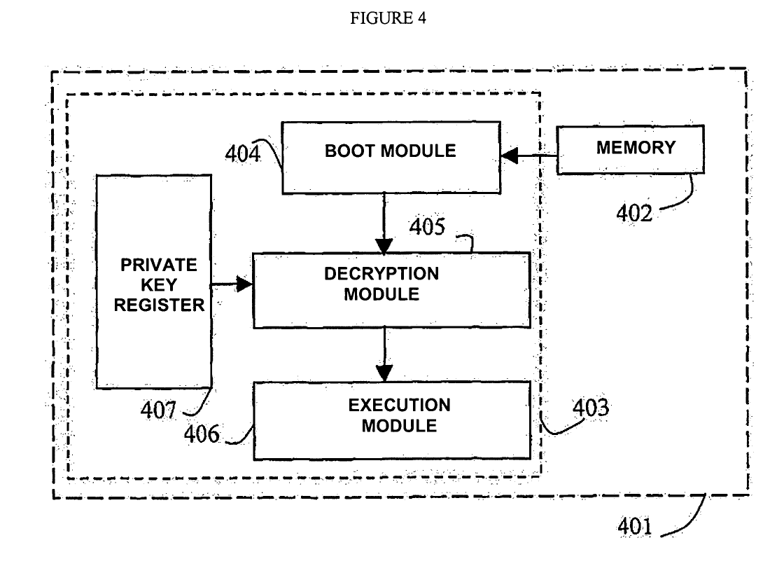

FIG. 4 illustrates an operation of a CPU 403 which is equipped with a decryption module 405 for decryption of information coming from a memory 402 according to the present invention. The program, encrypted with the public key 107 on a computer 401, is located in the memory 402. The CPU 403 utilizes selection of commands in machine code for their execution from the memory 402.

Before execution of the encrypted program, the private key 110 is entered to a private key register 407 located in the CPU 403. While executing the program, its encrypted executable code is loaded into the CPU 403 from a memory of a boot module 404 which forwards encrypted codes of executable commands into the decryption module 405. This module 405, utilizing the content of the private key register 407, decrypts command codes by converting them to condition suitable for execution by an execution module 406. The execution module 406 is responsible for execution of actions assigned by these commands. Moreover, the program access to its decrypted code can be restricted only to its execution, disallowing its reading in the way of data. This restriction may be used to prevent leakage of decrypted information in case when the program (e.g., as a result of a mistake resulted from a buffer overload) is used for reading its decrypted code and its further recording to any memory in decrypted mode.

This method can be further improved by introducing of encryption utilising methods as illustrated in FIG. 5. For this purpose one more register for storage of a symmetrical key 506 of a symmetrical cryptography algorithm can be foreseen in the CPU, where this key 506 is recorded after its decryption with the use of asymmetrical cryptographic algorithm 505, and one more decryption module 507. The decryption module 507 decrypts encrypted information using a symmetrical cryptography algorithm and the symmetrical key 506 from the above-mentioned register.

This scheme can also be extended not only to command codes, but to data processed by these commands. In this case it is also possible to encrypt information, received as a result of program execution, when such information is outputting from the CPU. For encryption, it is possible to use methods described above and shown in FIGS. 1 and 5, which are used as methods for the use of information by the Vendor 100.

FIG. 5 shows a further improvement of the method according to the present invention, given that symmetrical cryptography procedures may be executed significantly faster than asymmetrical cryptography procedures.

When selling the program, the Vendor 100 is randomly generating the symmetrical key 501 for the symmetrical algorithm. After that program 105 is encrypted with the symmetrical key (step 502). At the same time, the symmetrical key 501 is also encrypted using an asymmetrical cryptography (step 503). The public key 107 received from the Consumer 101 serves as an encryption key. In the step 504, the encrypted symmetrical key 501 is added to encrypted source code resulting in the encrypted program 108 which is forwarded to the Consumer 101.

The Consumer 101, while executing the encrypted program 108, primarily decrypts the symmetrical algorithm key (step 505) with using the private key 110, which creates a pair with the public key 107. The symmetrical key 506 obtained during this step, is identical to the symmetrical key 501 which is generated by the Vendor 100. After that, the symmetrical key 506 is used for decryption of an executable source code of the program (step 507). This results in getting the executable code, which coincides with the program 105 and is executed by the CPU of Consumer's computer.

In any of the described implementations of the present invention, it is recommended to erase decryption keys from the memory of the Consumer's computer immediately, if they are not required within a certain period of time (e.g., the key that is used for decryption of executable source code, is not required after decryption of this code until the next execution of this program).

Particular interest presents the utilization of a program protection according to the present invention of digital certificates which are issued by certificate authorities, which confirm matching of the Consumer's identification with the public key 107. In this case, at the attempt to distribute program copies together with the private key 110 for its decryption (which is typical for protection schemes utilising serial number), it is possible to detect a Consumer 101 who purchased this copy and provided the private key 110 for the distribution.

This method can also be easily applied to protection of information of any type (e.g., audio and video recordings), and not only to executable source codes. In this case, decryption may be executed by application utilising these data (e.g., applications for playback of audio or video recordings), or by an operating system.

Whereas the present invention was described in details, is must be clear, that various changes, replacements and amendments hereto can be made without departuring from its spirit and scope of invention, according to its description in the attached claims of the present invention.

1-64. (Cancelled).

65. A method for protecting against an unauthorized use of information, comprising the steps of:
obtaining by a Vendor a consumer public key;
encrypting the information using an asymmetrical cryptography algorithm with the consumer public key;
obtaining by the Consumer a consumer private key corresponding to the consumer public key; and
immediately before use of the information by the Consumer, decrypting the information with the consumer private key,
wherein when the information is not being used, the information is stored in a form encrypted with the consumer public key.

66. The method according to claim 65, wherein the step of obtaining the consumer public key is performed when the information is being acquired by the Consumer from the Vendor.

67. The method according to claim 66, wherein the consumer public key is obtained from a digital signature when an acquisition order for the information is placed.

68. The method according to claim 66, wherein the Vendor obtains the consumer public key from a key storage related to the Consumer.

69. The method according to claim 65, further comprising the step of:
deleting the decrypted information after the use of the information by the Consumer

70. The method according to claim 65, wherein the information includes a first portion and at least one second portion and wherein when the first portion is decrypted immediately before its use, the at least one second portion remains encrypted.

71. The method according to claim 70, wherein the first portion is deleted after being used.

72. The method according to claim 66, wherein the Vendor obtains the consumer public key from a digital certificate, the digital certificate confirming an identity of the Consumer.

73. The method according to claim 72, wherein the Vendor checks if the digital certificate at least one of is valid and was not revoked.

74. The method according to claim 65, wherein a program is executed on an equipment of the Consumer, the executed program checking if the consumer private key was revoked before the use of the encrypted information.

75. The method according to claim 65, further comprising the step of:
generating by the Vendor the consumer public key and the consumer private key.

76. The method according to claim 75, further comprising the step of:
providing by the Vendor the consumer private key to the Consumer.

77. A method for protection against an unauthorized duplication of information, comprising the steps of:
obtaining by a Vendor a consumer public key;
generating by the Vendor a random key for an asymmetrical cryptography algorithm;
encrypting the information using the asymmetrical cryptography algorithm and the random key;
encrypting the random key using the asymmetrical cryptography algorithm and the consumer public key;
obtaining by the Consumer a consumer private key corresponding to the consumer public key;
decrypting the encrypted random key obtained by the Consumer from the Vendor using (a) a further asymmetrical cryptography algorithm corresponding to the asymmetrical cryptography algorithm and (b) the consumer private key, wherein the random key is decrypted immediately before use of the information by the Consumer, and wherein when the information is not being used, the random key is stored in a form decrypted using the consumer public key; and
decrypting by the Consumer the information obtained from the Vendor using the further asymmetrical cryptography algorithm and the decrypted random key.

78. The method according to claim 77, wherein the consumer public key is provided when information is being acquired by the Consumer from the Vendor.

79. The method according to claim 78, wherein the consumer public key is provided from a digital signature when an acquisition order is placed.

80. The method according to claim 77, wherein the Vendor obtains the consumer public key from a key storage related to the Customer.

81. The method according to claim 77, further comprising the step of:
after the decrypted information is used, destroying the decrypted information.

82. The method according to claim 77, wherein the information includes a first portion and at least one second portion and wherein when the first portion is decrypted immediately before its use, the at least one second portion remains encrypted.

83. The method according to claim 82, wherein a first random key is utilized for an encryption of a first of the at least one second portion and a second random key is utilized for an encryption of a second of the at least one second portion, the first key being different from the second key.

84. The method according to claim 77, wherein the decrypted random key is destroyed after being used for decryption of the encrypted information.

85. The method according to claim 82, wherein the decrypted first portion is destroyed after being used.

86. The method according to claim 77, wherein the Vendor obtains the consumer public key from a digital certificate, the digital certificate confirming an identity of the Consumer.

87. The method according to claim 86, wherein the Vendor checks if the digital certificate at least one of is valid and was not revoked.

88. The method according to claim 77, wherein a program is executed on an equipment of the Consumer, the executed program checking if the consumer private key was revoked before the use of the encrypted information.

89. The method according to claim 77, further comprising the step of:
generating by the Vendor the consumer public key and the consumer private key.

90x. The method according to claim 89, further comprising the step of:
providing by the Vendor the consumer private key to the Consumer.

91. The method according to claim 83, where the first and second random keys are deleted after decrypting of the first and second of the at least one second portions.

92. A system for protecting against an unauthorized duplication of information, comprising:
a vendor arrangement obtaining a consumer public key and encrypting the information using an asymmetrical algorithm with the consumer public key; and
a consumer arrangement obtaining a consumer private key corresponding to the consumer public key and decrypting the information, immediately before its use by the Consumer, using the asymmetrical algorithm with the consumer private key,
wherein when the information is not being used, the consumer arrangement stores the information in a form encrypted with the consumer public key.

93. The system according to claim 92, wherein the consumer public key is provided when the information is being acquired.

94. The system according to claim 93, wherein the consumer public key is obtained from a digital signature when an acquisition order for the information is placed.

95. The system according to claim 93, wherein the consumer public key is transmitted via a computer network.

96. The system according to claim 92, wherein the consumer public key is obtained from a key storage related to consumer's information.

97. The system according to claim 96, wherein the consumer public key is at least one of requested and acquired via a computer network.

98. The system according to claim 92, wherein an acquisition order for purchasing of the information is transmitted via a computer network.

99. The system according to claim 92, wherein the information is a software program which is executable by a CPU of the consumer arrangement, the program decrypting itself prior to the execution utilizing the consumer private key.

100. The system according to claim 92, wherein the decrypted information is destroyed after being used.

101. The system according to claim 92, wherein the information includes a first portion and at least one second portion and wherein when the first portion is decrypted immediately before its use, the at least one second portion remains encrypted.

102. The system according to claim 101, wherein the decrypted first portion is destroyed after being used.

103. The system according to claim 92, wherein the consumer arrangement includes a CPU and a memory, the information being stored in the memory and encrypted utilizing the public key, the CPU including a first module decrypting the information using the consumer private key prior to utilization of the information by a second module so that decrypted information does not exist outside the CPU.

104. The system according to claim 92, wherein the consumer public key is obtained from a digital certificate, the digital certificate authenticating a consumer's identity.

105. The system according to claim 109, wherein the digital certificate is checked if it at least one is valid and was not revoked.

106. The system according to claim 94, wherein the program, which is executable on the consumer arrangement prior to the utilization of the encrypted information, checks if the consumer private key was revoked.

107. The system according to claim 92, wherein the consumer private and public keys are generated by a Vendor.

108x. The system according to claim, 107, wherein the Vendor transmits the consumer private key is forwarded to Consumer.

109. The system according to claim 99, wherein the program executed by the CPU does not have an access to reading of its decrypted executable code.

110. A system for protecting against unauthorized use of information, comprising:
a vendor arrangement obtaining a consumer public key and generating a random key for a symmetrical cryptography algorithm, the vendor arrangement encrypting the information using the symmetrical cryptography algorithm and the random key and encrypting the random key using the symmetrical cryptography algorithm and the consumer public key; and
a consumer arrangement obtaining a consumer private key corresponding to the consumer public key, the consumer arrangement decrypting the encrypted random key, immediately before use of the information, using an asymmetrical cryptography algorithm and the consumer private key,
wherein when the information is not being used, the random key is stored in a form encrypted using the consumer public key, and
wherein the consumer arrangement decrypts the information using the symmetrical cryptography algorithm and the decrypted random key.

111. The system according to claim 110, wherein the consumer public key is provided when the information is acquired.

112. The system according to claim 111, wherein the consumer public key is provided from a digital signature when an acquisition order is placed.

113. The system according to claim 111, wherein the consumer public key is transmitted via a computer network.

114. The system according to claim 110, wherein the consumer public key is obtained from a key storage related to customer information.

115. The system according to claim 114, wherein the consumer public key is at least one of (i) requested and (ii) obtained via a computer network.

116. The system according to claim 110, wherein the information is transmitted via a computer network.

117. The system according to claim 110, wherein the information is a program intended for an execution by a processor of the consumer arrangement, the program decrypting itself before the execution using the consumer private key.

118. The system according to claim 110, wherein the decrypted information is deleted after being used.

119. The system according to claim 110, wherein the information includes a first portion and at least one second portion, and wherein, when the first portion is decrypted immediately before its use, the at least one second portion remains encrypted.

120. The system according to claim 119, wherein a first random key is utilized for an encryption of a first of the at least one second portion and a second random key is utilized for an encryption of a second of the at least one second portion, the first random key being different from the second random key.

121. The system according to claim 110, wherein the random key is destroyed after being used for decrypting of the information.

122. The system according to claim 119, wherein the first portion is destroyed after being used.

123. The system according to claim 110, wherein the consumer arrangement includes a CPU and a memory, the information being stored in the memory and encrypted utilizing the random key, the CPU including a first module decrypting the information from the memory utilizing the random key prior to utilization of the information by a second module and the CPU so that the decrypted information does not exist outside of the CPU.

124. The system according to claim 123, wherein the CPU includes a third module decrypting the random key utilizing the consumer private key prior to utilization of the random key in the second module so that the decrypted random key does not exist outside of the CPU.

125. The system according to claim 117, wherein the program executable on the CPU does not have an access to reading its decrypted executable code.

126. The system according to claim 117, wherein the executable program does not have an access to reading its decrypted random key.

127. The system according to claim 110, wherein the consumer public key is obtained from a digital certificate which authenticates a consumer's identity.

128. The system according to claim 127, wherein a Vendor checks if the digital certificate at least one of is valid and was not revoked.

129. The system according to claim 117, wherein the program, which is executable on the consumer arrangement prior to utilization of the encrypted information, checks if the consumer private key was revoked.

130. The system according to claim 110, wherein the consumer private and public keys are generated by a Vendor.

131x. The system according to claim 130, wherein the consumer private key is transmitted to a Consumer.

132. The system according to claim 120, wherein the first and second random keys are destroyed after being used for decrypting the first and second of at least one second portions.

133. The system according to claim 110, wherein the information includes at least one of a software program, audio data and video data.
